(19) United States
(12) Patent Application Publication
(10) Pub. No.: US 2007/0090170 A1
(43) Pub. Date: Apr. 26, 2007

(54) Method of making a circuitized substrate having a plurality of solder connection sites thereon

(75) Inventors: Steven W. Anderson, Newark Valley, NY (US); Scott P. Moore, Apalachin, NY (US); Cheryl L. Palomaki, Endicott, NY (US); Son K. Tran, Endicott, NY (US)

Correspondence Address: LAWRENCE R. FRALEY;Hinman, Howard & Kattell, LLP, 700 Security Mutual Building, 80 Exchange Street, Binghamton, NY, 13902-5250, US

(73) Assignee: Endicott Interconnect Technologies, Inc., Endicott, NY (US)

(21) Appl. No.: 11/253,659

(22) Filed: Oct. 20, 2005

(51) Int. Cl. B23K 31/02; B23K 31/00; B23K 1/08

(52) U.S. Cl. 228/180.22; 228/39

(57) ABSTRACT

A method of making a circuitized substrate in which solder material (e.g., in paste form) is deposited through a screen onto individual conductors in a spaced pattern of individual solder “islands”. A solder flux is then deposited onto the “islands” causing these to spread out and form a continuous solder layer across the conductor's upper surface. The solder layer is then capable of coupling to an external conductor such as a solder ball, to form an electrical assembly such as might be used within an information handling system such as a personal computer.

### TECHNICAL FIELD

The present invention relates to forming solder connections for coupling electronic components onto circuitized substrates such as printed circuit boards (or cards) and chip carriers. The invention is particularly related to such solder connections which are of highly dense concentrations and thus extremely small in size. Further, the invention is related to electrical assemblies such as information handling systems adapted for using such circuitized substrates.

### CROSS REFERENCE TO CO-PENDING APPLICATION

In Ser. No. 10/968,929, filed Oct. 21, 2004, there is defined a method of making a circuitized substrate in which two solder deposits, of the same or different metallurgies, are formed on at least two different metal or metal alloy conductors and plated-through-holes (PTHS). In an alternative embodiment, the same solder compositions may be deposited on conductor and PTHS of different metal or metal alloy composition. In each embodiment, a single commoning layer (e.g., copper) is used, and partially removed following the first deposition. The solder is deposited using an electro-plating process (electro-less or electrolytic) and the commoning bar in both depositing steps. This application is assigned to the same Assignee as the present invention.

### BACKGROUND OF THE INVENTION

The use of soldering is well known for forming electrical connections between electronic components such as semiconductor chips, chip carriers, modules, resistors, capacitors, etc. and the electrically conductive pads (or sites) on the external surface of circuitized substrates such as printed circuit boards and chip carriers. Several different forms of such processes have evolved over the years, including, e.g., wave soldering wherein a printed circuit board, populated with such components, is passed over a crest of a molten solder wave, immersion wave soldering in which a conventional solder wave submerged in a heated flux bath is utilized, and vapor phase reflow soldering which utilizes the latent heat of vaporization stored in a saturated vapor of inert fluorinated organic compounds (e.g., a family of same sold under the name Fluorinert by the Minnesota Mining and Manufacturing (3M) Company). Additional description of various solder processes is provided hereinbelow.

The electronics industry of today demands many products, particularly those utilizing circuitized substrates, to be of smaller size, as the trend toward smaller components and higher integration densities of integrated circuits continues. Customers want smaller computers, calculators, printers, telephones, etc., all with increased functional capabilities. To meet these demands, manufacturers of circuitized substrates must develop new processes for the successful (quick, relatively inexpensive, and adaptable to mass production) application of solder to extremely small areas and in carefully controlled volumes. To make such processes all the more complex, the resulting connections must not be so close as to allow solder “bridging” between adjacent connections, excessive “doming” (especially if the final solder configuration is to eventually be coupled to a solder ball of typically spherical shape), etc.

A widely used procedure, particularly for direct attachment of a semiconductor chip, chip carrier or like components onto a board or module, is known in the industry as surface mount technology (SMT). One form of such technology utilizes what are referred to as solder “pre-forms”, possibly including a desired flux, for application to locations where solder connections are to be made. Such pre-forms are formed (solidified) solder elements which are positioned on the designated substrate pads and are then heated (re-flowed) once the components are in place, until solidification once again occurs and the final couplings (connections) realized. Use of solder pre-forms has proven relatively successful for forming solder connections at small sizes and close spacings since the volume of solder contained in each pre-form can be controlled in a relatively accurate manner. However, because such pre-forms must be handled by automated placement equipment in order to be effectively utilized on a mass production basis, the required size for such handling prohibits adequate miniaturizing to the scales demanded by many of today's applications.

One other known process involves use of pulverized solder material in a viscous binder in the form of a paste which can be applied by printing through a stencil, also referred to, simply, as stenciling. A quantity of such paste is deposited onto each site and covers the upper surface thereof While this process has been largely successful in applying solder to locations having sizes and spacings smaller than those where solder pre-forms are used, the accuracy with which the dispensed volume of solder is controlled may be limited. Because of the relatively harsh (primarily high temperatures) conditions associated with soldering, stenciling may present drawbacks due to the possibility of contamination, wear and damage to the stencil masks through which the paste is extruded. Irregular solder paste deposition can result in one or more connections not being achieved, resulting in possible scrapping and/or re-working of the completed final product (e.g., a printed circuit board having several components mounted thereon), a very costly and therefore undesirable result. Irregularities of solder paste distribution may also be caused by the separation of the stencil mask from the substrate surface onto which the solder paste is being deposited. Still further, the minimum size of particles used for the solder material which can be formed is limited by the process by which the particles themselves are formed. That is, particles of smaller size are typically formed by atomization and solidification of liquid solder, causing an increase in the ratio of surface area-to-volume as size decreases, in turn causing an increase in oxide-to-metal volume for a fixed thickness of oxide on the surface of the particle and a greater viscosity of the paste for a given metal loading of the paste having the particles. Lowering metal loading and viscosity, in turn, requires a thicker stencil to obtain the desired volume of metal with higher aspect ratio openings, which is contrary to the normal and desirable operating requirements for stencils in order to accommodate small feature sizes since high aspect ratio stencil openings (and high viscosity) reduce the ability of the paste to release from the stencil. Thus, there may occur a trade-off between process complexities and requirements which limits the deposit size and stenciling resolution which can be achieved and control of the locations to which either the paste or the solder, itself, may flow. Still further, solder stenciling processes and the processes for fabrication of masks through which stenciling is done may not support the close spacing or fine pitch of solder connection locations which can be formed by photo-lithographic technologies which are typically utilized as part of the circuit defining process. Registration of the stencil with connection locations also becomes difficult when extremely close spacing of connections is required.

Further, it is also known that, in the process of making a solder connection to a copper conductor (copper being one of the most widely used metals for substrate pads, lines, etc of a substrate's circuit pattern), some copper may be removed from the pad and become part of the solder connection material. This may become critical in some applications in microelectronic manufacturing, particularly in devices which are subjected to high temperature operation and thermal cycling, since tin-copper inter-metallic compound precipitates may be formed (that is, when tin is part of the solder composition as is also well known for most solders). Further, the solubility of copper in typical solder materials is usually very small, e.g., on the order of only about 0.3%. Therefore, most excess copper in the solder materials will be in the form of such inter-metallic compounds. Inappropriate amounts of copper in the solder material may degrade the reflow characteristics of the solder. Specifically, when conductors are closely spaced, it is desirable that the solder “pulls back” toward the conductor (pad) on which the connection is made and away from adjacent conductors. This action also maximizes the conductive material in the connection and provides for a stable configuration of the solder material even when softened by normal or abnormal temperatures after the final substrate product is put into service (e.g., as part of a computer). Such reflow may also be adversely affected by small amounts of copper on the surrounding substrate, allowing such areas to be partially wetted or bridged. One apparent solution known at the present time is to dissolve such copper deposits in the solder (which is often difficult due to the relatively low solubility of copper in solder materials, especially when the conductor also provides a source of copper solute in the solder material), to react the copper from the solder with other materials, or use aggressive fluxes. These “solutions” typically mandate longer reflow times and may even compromise the integrity of the resulting, formed solder connection. Other materials, such as gold, are also known to have low solubility in solder and exhibit similar adverse effects on solder connections and reflow.

It is also known in the soldering art, especially that portion thereof involving printed circuit boards, to utilize a solder-mask material. Solder-mask materials are formed of dielectric materials able to withstand high reflow temperatures, and are deposited on the substrate in a pattern which defines (through openings therein) the eventual conductive pads or signal lines to receive solder. The solder is deposited through the openings onto the selected pads or lines and then reflowed when engaging the contact or solder ball of the electronic component which is being positioned on the substrate. Several types of solder-mask materials are known, including those known as dry film solder mask (DFSM) materials (examples including those sold under the product name VACREL by E.I. duPont de Nemours & Company and DynaMASK by the Shipley Company) and liquid photo-imageable materials (one example being sold under the product name Ronascreen SPSR 5600 by the same Shipley Company).

In U.S. Pat. No. 4,104,111 (Mack), there is described a printed circuit board manufacturing process which employs initial chemical deposition of copper on a pre-drilled substrate followed by electroplating build-up of conductors to a desired pattern. The conductors are then passivated by thin plating with a mechanically durable, chemically passive metal. To provide solder compatibility in areas where connections are to be made to the printed circuits, a plating of tin/lead is applied in those areas while making all other areas “to eliminate plating”. The remaining exposed copper is then etched away. An insulating solder mask is then applied.

In U.S. Pat. No. 4,325,780 (Schulz, Sr.), there is described a method of applying solder to a conductive pad and holes of a circuit board in which a tin-lead solder alloy layer is electrolytically deposited over a copper layer. Electrolytic deposition is claimed to avoid the difficulties inherent in fluxing and bath-applying molten solder. According, this patent alleges that there is no “gross” thermal shock to the board, the possibility of plugging of the drilled bore holes is avoided, and the likelihood of bridging between circuit elements and resultant short-circuiting is minimized. Elimination of exposure to flux chemicals is said to avoid introducing chemically active contaminants into the circuit board. The terminal pad base or fusion joint metal is commonly selected to be a tin-lead solder alloy although other electrically conductive materials may be employed, such as tin alone, silver or, in the case of computer circuit boards, gold.

In U.S. Pat. No. 4,487,654 (Coppin), there is described a method of manufacturing a printed circuit board utilizing a solder mask over bare copper for circuit traces and ground planes. The method includes the step of electroplating a very thin coating of tin-lead over the circuit traces, ground planes, holes and circuit pads prior to selectively coating only the pads and holes with a relatively thick coating of tin-lead solder plate. After removing the plating resist which defines the areas for selective solder coating, the board is chemically etched and then mechanically scrubbed to roughen the surface of and reduce the thickness of the thin solder plate. A solder mask may be applied over circuit traces and ground planes prior to reflowing the thick coating of solder plate. Assembled printed circuit boards are then wave soldered.

In U.S. Pat. No. 4,528,259 (Sullivan), there is described a printed circuit board soldering process in which a solder mask is laid down with a flat planar surface by means of a liquid photopolymer solder mask layer deposited, photo-exposed and developed to uncover those circuit trace positions such as through holes and connector pads for further processing. Then a very thin copper layer is chemically deposited over the surface area and a resist layer is laid down as a cover insulating layer on the flat surface so that a thicker layer of copper may be electrolytically plated over the uncovered circuit traces. In this manner the conductive area about each of the connector pads is increased by plating on the sidewalls of the solder mask layer which surround the connector pads. Additionally the photopolymer flat surface is glossy and does not strongly adhere to the deposited thin copper layer as does the sidewall and conductor pad areas, thereby permitting the cover insulating layer and the thin copper layer to be readily removed from the flat planar surface by mechanical methods

In U.S. Pat. No. 4,745,004 (Schwerin), there is described a method and apparatus for transporting work through a series of work processing stations by moving the work along a path extending past the stations to successive positions along the path opposite the stations, respectively, and at each position extending and retracting the work into and from the respective station for processing of the work therein. The method and apparatus are designed to coat or plate the conductors and thru-holes of printed circuit boards with solder by mounting the circuit boards in rack-like work holders, transporting the work holders in succession from an feed station to a release station along a path extending over a series of tanks containing liquid baths of acid, rinse solution, flux, solder/oil and final wash, respectively, and extending and retracting each work holder downwardly into and upwardly from each tank.

In U.S. Pat. No. 4,978,423 (Durnwirth, Jr. et al), there is described a method of providing solder on selected portions of a printed circuit board. Solder is first electroplated over copper conductor patterns on the board by means of a first photoresist layer. After stripping the first photoresist, a second photoresist layer is laminated over the board and developed to expose selected portions of the solder. The exposed portions are selectively stripped. The copper exposed by the selective stripping is then subjected to a scrubbing while the photoresist protects the remaining solder. The second photoresist is then removed.

In U.S. Pat. No. 5,234,157 (Fletcher), a component or connector lead is soldered to a bare copper metallized area on a circuit board using core solder by manually applying heat from a heated tip to a separate one of the lead and metallized area. As the heat is being applied, a vacuum is drawn in the region where the solder is applied to the lead and/or metallized area to draw off any flux vapors created upon heating of the solder. At the same time, hot air is also directed into the region where the solder is being applied to maintain the flux vapors, created upon heating of the solder, in their vaporous state to facilitate such vapors being drawn off, thereby reducing the amount of flux residues resulting from the soldering operation.

In U.S. Pat. No. 5,398,865 (Mittag), there is described an apparatus and process which prepares surfaces on components, boards and the like for assembly and solder joining. Oxides and other coatings are removed from the surfaces to be soldered without having to solder coat the surfaces prior to joining. A composition of a polymer and an activator is applied to the surfaces, the polymer being thermally de-polymerizable. The patent states that the composition is able to remove oxides from the surfaces. The surfaces are heated after application of the polymer and activator to de-polymerize the polymer. Solder is then applied to solder join the surfaces.

In U.S. Pat. No. 5,597,469 (Carey et al), there is described a process in which small, closely spaced deposits of solder materials may be formed by depositing a layer of conductive material over surfaces of a dielectric layer having apertures or recesses (e.g. blind apertures) and conductors and/or pads exposed by those apertures or recesses, masking regions of the conductive material with a further patterned dielectric layer, electroplating solder materials onto regions of the conductive material exposed by the mask, removing the mask and portions of the conductive material by selective etching, and thereafter reflowing solder away from at least a portion of the surfaces of the apertured dielectric layer. Fluid jet sparging and cathode agitation are also utilized. Excess conductor material in the resulting solder deposit is allegedly avoided by replacing conductor material with a constituent component of a solder material in an immersion bath prior to the electroplating step of the process.

In U.S. Pat. No. 5,672,260 (Carey et al), a continuation of U.S. Pat. No. 5,597,469 above, there is described a method of forming solder deposits on a solder wettable material which includes the steps of electroplating solder materials onto portions of a conductive layer on a first layer of non-solder wettable material having apertures therein and covering a portion of the solder wettable material. Portions of the conductive layer are exposed during the electroplating by additional apertures in a second layer of non-solder wettable material, these additional apertures having dimensions sized to define a volume of solder material to be deposited by the electroplating step. The deposited solder materials are then reflowed away from a portion of the surfaces of the first layer of non-solder wettable material.

In U.S. Pat. No. 5,863,812 (Manteghi), there is described a method for fabricating a chip size package which includes the step of forming a laminated substrate which consists of a dielectric layer and a highly conductive layer disposed thereon. Holes are drilled into the dielectric layer. A desired pattern is applied to the conductive layer. A chip structure is formed which consists of a silicon die and an insulating layer disposed thereon. Gold bumps are applied to the top surface of the bonding pads. The laminated substrate is bonded to the chip structure via the holes and gold bumps. A solder mask is applied over the top surface of the conductive layer of the laminated substrate so as to form selective solder areas. Finally, solder balls are attached to the selective solder areas.

In U.S. Pat. No. 5,873,511 (Shapiro), the placement of solder “balls” in a ball grid array package is accomplished by placing a solder strip in contact with the top surface of the ball grid array carrier. The pulsing of a laser directed at the solder in discrete positions permits the transfer of the solder to the gold “dot”, of an array of “dots”, on the carrier in registry with the laser output when activated. Selective solder placement is possible and increasingly higher throughput is achieved by the use of laser diode bars or optical fiber fans to effect solder transfer to a plurality of dots of the array simultaneously. The entire process is described as capable of being automated by making the solder strip continuous through a recycling station arranged along a path along which the solder strip moves to the position where the carrier and the solder strip are moved into juxtaposition. The use of a transparent strip with a pattern of holes filled with solder paste permits easy transfer of the solder to the gold dots or islands on the carrier in registry with laser beam.

In U.S. Pat. No. 6,022,466 (Tamarakin et al), there is described a process for plating gold on a multi-layered printed circuit board. In one embodiment, first copper features for plating gold thereon and second copper features for plating copper thereon are selected on the board's external surface. The first copper features are internally connected to the second copper features. An etch-resist is deposited on the first and second copper features. The second copper features are masked, while a region containing the first copper features is exposed. Copper from the region is etched. The etch-resist on the first copper features is removed. Gold is then plated on the first copper features.

In U.S. Pat. No. 6,586,683 (Arrington), there is described method of fabricating a printed circuit board which includes an electrically insulating substrate, and first, second, and third sets of conductors formed on a top surface of the substrate. The method includes forming an oxide layer on one set of conductors, forming a solder mask on the oxide layer, forming a composite layer on another set of conductors, and forming a solder layer on at least a portion of the remaining set of conductors. A commoning bar is used as part of the method. The patent mentions that the conductors may be of different metallurgies.

In U.S. Pat. No. 6,645,841 (Kever), there is described the selective application of solder “bumps” in an integrated circuit package. These solder bumps are selectively applied in a solder bump integrated circuit packaging process so that portions of a circuit can be effectively disabled. The bumps may be selectively applied either to a die or to the substrate using multiple solder masks, one for each pattern of solder bumps desired, or these can be otherwise applied in multiple patterns depending upon which portions of the circuitry are to be active and which are to be disabled.

As will be understood from the following, the present invention provides a new and unique process for making circuitized substrates such as chip carriers and printed circuit boards in which solder layers are applied to conductive surfaces of individual conductors in such a manner so as to substantially reduce “doming” of the solder and thereby assure a proper surface to which a contact such as a solder ball may engage for eventual electrical coupling to the component having the solder ball thereon. Minimal solder usage is possible while still assuring effective wetting of substantially the entire conductive surface of each of the conductors with a fine layer of solder. The process defined herein is capable of being implemented with conventional manufacturing equipment along with at least one other element specifically designed for ready compatible use therewith, thereby assuring relatively reduced costs associated with such processing. Other advantageous features of this invention are discernible from the following description.

It is believed that such a process represents a significant advancement in the circuitized substrate art.

### OBJECTS AND SUMMARY OF THE INVENTION

It is, therefore, a primary object of the present invention to enhance the circuitized substrate art.

It is another object of the present invention to provide a new and unique method for applying solder materials onto metal conductors in a facile manner adaptable to mass production.

It is yet another object of the invention to provide such a method which is capable of providing such solder plating on conductors in a highly dense pattern.

It is still another object of the invention to provide such a method which can be successfully performed using, for the most part, conventional manufacturing apparatus, thereby assuring cost savings for the products made using this method.

It is yet another object of the invention to provide a method of forming solder connections at sizes and spacings comparable to current photolithography processes.

It is another further object of the invention to provide resulting solder connections which possess stable shapes, even at elevated temperatures.

According to one aspect of the invention, there is provided a method of making a circuitized substrate which comprises providing a substrate having a first surface thereon, providing a plurality of metal conductors on the first surface in a spaced-apart pattern, aligning a screen having a plurality of patterns of openings therein over the first surface such that selected ones of the patterns of openings align with selected ones of the metal conductors, depositing a quantity of solder material through the selected ones of the plurality of patterns of openings onto the selected ones of metal conductors such that this solder material does not entirely cover the metal conductors, depositing a quantity of solder flux material onto the selected ones of the metal conductors having the quantity of solder material thereon to cause the solder material to spread and form a layer which substantially entirely covers the metal conductors, and thereafter heating the formed layer.

### BRIEF DESCRIPTION OF THE DRAWINGS

FIGS. 1-3 and 6-8 are much enlarged, side elevational views, in section, illustrating the various steps of making a circuitized substrate according to one embodiment of the invention;

FIGS. 4 and 5 are partial plan views, on an enlarged scale over the views of FIGS. 1-3 and 6-8, illustrating examples of the plurality of openings patterns capable of being used in the screen used in the invention;

FIG. 9 is a side elevational views, in section, and on the same scale as FIGS. 1-3 and 6-8, illustrating the coupling of the solder formed on a substrate conductor using the teachings of the invention with an external conductor of an electronic component to form an electrical assembly according to one embodiment of the invention; and

FIG. 10 is a perspective view illustrating an information handling system capable of using the circuitized substrate made in accordance with the teachings of this invention.

### BEST MODE FOR CARRYING OUT THE INVENTION

For a better understanding of the present invention, together with other and further objects, advantages and capabilities thereof, reference is made to the following disclosure and appended claims in connection with the above-described drawings. Like figure numbers will be used from FIG. to FIG. to identify like elements in these drawings.

By the term “conductor” as used herein is meant a metal pad, line (sometimes referred to in the art as a “trace”) or similar member located on a substrate and adapted for having solder material applied thereto such that a solder connection may be formed between the pad, line or similar member and another electrically conductive element such as a solder ball associated with a chip or chip carrier.

By the term “electro-plating” as used herein is meant to include both electroless (also referred to as electro-less) and electrolytic (also referred to as electro-lytic) plating methodologies, or a combination of various aspects of both. As known, such processing in its simplest form involves passing electrical current from an anode through an electrolyte to bring positive ions of the plating metal to a cathode. It is then joined with negative electrons created by the cathode and transforms into the metal coating. The metal coating bonds to the cathode and thus the electroplating process is complete. The theory of such plating can be explained in a simple formula:
M⁺¹ye⁻¹−>M°
wherein M stands for the plating metal (the M charge changes with each type of metal), and y equals the number of electrons needed to cancel out the charge. These combined make the final metal coating or M (degree). One of the most significant aspects of this invention is that it allows the formation of a discrete, precise quantity of solder on the surface of a metal conductor without the need for electro-plating of the conductor prior to such formation as is often necessary in many conventional conductors used in substrates such as printed circuit boards and chip carriers.

By the term “circuitized substrate” as used herein is meant to include substrates having at least one (and preferably more) dielectric layer(s) and a plurality of metal conductors thereon. Such substrates also may include one or more internal conductor layers which function as signal, ground and/or power planes in the finished product. In many cases, such substrates may also include a plurality of plated-through-holes (PTHS). Examples of dielectric materials suitable for use in such substrates include fiberglass-reinforced epoxy resins (some referred to as “FR-4” dielectric materials in the art), polytetrafluoroethylene (Teflon), polyimides, polyamides, cyanate resins, photoimageable materials, and other like materials. One good example of such a material is produced under the product name “DriClad” dielectric material by the Assignee of this invention, Endicott Interconnect Technologies, Inc. (“DriClad” is a registered trademark of Endicott Interconnect Technologies, Inc.). If internal conductor layers are used, these are typically of metal such as copper or copper alloy, and may include plated metallurgy such as nickel and gold on selected parts thereof. The preferred metal for the substrate's external conductors is copper or copper alloy. Further examples will be described in greater detail hereinbelow. If the dielectric materials for the structure are of a photoimageable material, it is photoimaged or photopatterned, and developed to reveal the desired circuit pattern, including any PTHS, if utilized. The dielectric material may be curtain-coated or screen-applied, or it may be supplied as dry film. Final cure of the photoimageable material provides a toughened base of dielectric on which the desired electrical circuitry is formed. An example of a specific photoimageable dielectric composition includes a solids content of from about 86.5 to about 89%, such solids comprising: about 27.44% PKHC, a phenoxy resin; 41.16% of Epirez 5183, a tetrabromobisphenol A; 22.88% of Epirez SU-8, an octafunctional epoxy bisphenol A formaldehyde novolac resin; 4.85% UVE 1014 photoinitiator; 0.07% ethylviolet dye; 0.03% FC 430, a fluorinated polyether nonionic surfactant from 3M Company; 3.85% Aerosil 380, an amorphous silicon dioxide from Degussa AG (having a business location in Dusseldorf, Germany) to provide the solid content. A solvent is present from about 11 to about 13.5% of the total photoimageable dielectric composition. It is believed that the teachings of the instant invention are also applicable to what are known as “flex” circuits (which use dielectric materials such as polyimide) and those which use ceramic or other non-polymer type dielectric layers, one example of the latter being what are referred to as multi-layered ceramic (MLC) modules adapted for having one or more semiconductor chips mounted thereon.

By the term “electronic component” as used herein is meant components such as semiconductor chips, resistors, capacitors and the like, which are adapted for being positioned on the external conductive surfaces of such substrates as PCBs and chip carriers and possibly electrically coupled to other components, as well as to each other, using, for example the PCB's or chip carrier's internal and/or external circuitry.

By the term “electrical assembly” is meant at least one circuitized substrate as defined herein in combination with at least one electronic component electrically coupled thereto and forming part of the assembly. Examples of known such assemblies include chip carriers which include one or more semiconductor chips as the electrical components, the chip(s) usually positioned on the substrate and coupled to wiring (e.g., pads) on the substrate's outer surface or to internal conductors using one or more thru-holes. Perhaps the most well known such assembly is the conventional printed circuit board (PCB) having several external components such as resistors, capacitors, modules (including one or more chip carriers) etc. mounted thereon and coupled to the internal circuitry of the PCB. One example of a chip carrier of this type is sold under the product name “Hyper-BGA” chip carrier by the Assignee of this invention, Endicott Interconnect Technologies, Inc. Hyper-BGA is a registered trademark of Endicott Interconnect Technologies, Inc.

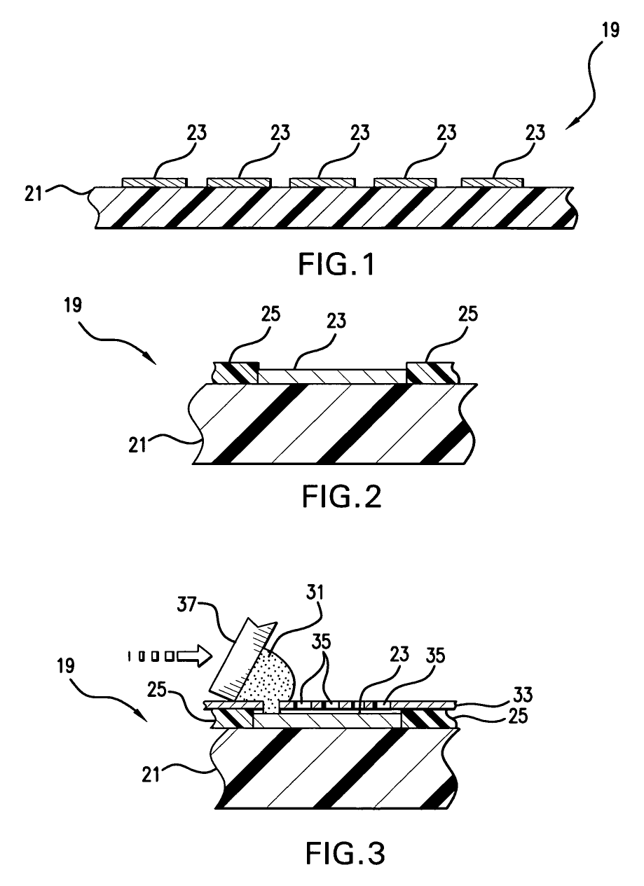

In FIG. 1, there is shown a substrate 19, including a layer 21 of dielectric material having a plurality of conductors 23 thereon. Substrate 19 is shown in its simplest form, meaning that it may include more layers of dielectric material and more conductors than the five shown therein. It is also possible for the substrate to include one or more internal conductive layers, which will function as power, ground and/or signal planes in the final circuitized substrate formed in accordance with the teachings herein. Such additional layers, both dielectric and conductive, are well known in the art as exemplified by one or more of the several patents cited above, and further description is not considered necessary. Although only five conductors 23 are shown, the invention is also not limited thereto. In one example, a total of as many as about 10,000 conductors may be formed on the substrate's upper surface, depending on the operational requirements for the finished product. For example, this relatively high number may be desirable if the substrate is to be used as a chip carrier and have one or more semiconductor chips mounted thereon. Alternatively, such a high number may be desired if the substrate is to be a PCB, and it is desired to mount and couple one or more electronic components, including a chip carrier (or carriers) thereon. The preferred dielectric material for layer 21 is comprised of one of the above-identified materials, including fiberglass-reinforced epoxy resin, polytetrafluoroethylene, polyimide, polyamide, cyanate resin, photoimageable material, or possibly a combination of two or more of these materials. The specifically referenced “DriClad” dielectric material is one preferred example. It is presently envisoned that the dielectric material may also be of ceramic or similar non-polymeric materials, or also of a thin, flexible dielectric material of much less thickness than conventional PCB substrate layers. One example of the latter is the afore-mentioned polyimide material, which is conventionally used in many “flex” substrates, while less often used in thicker conventional PCB substrates.

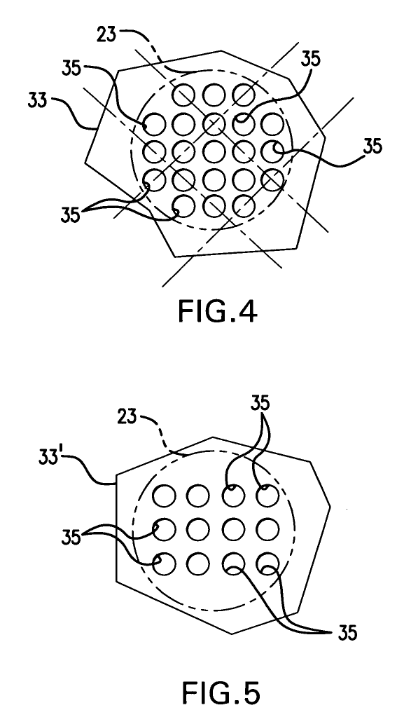

In one embodiment, layer 21 may have a thickness of from about 30 micrometers (um) to about 60 μm, while each of the conductors 23 has a thickness of from about 12 um to about 25 μm. These conductors are also preferably cylindrical in shape, thus presenting a round (annular) shape when viewed from the top. Such a shape is shown in phantom in FIGS. 4 and 5. In this embodiment, each has a diameter of about 550 μm and is spaced approximately 450 μm from the nearest adjacent conductor(s). This extremely close spacing of conductors of this size which are successfully covered with solder layers in the manner defined herein illustrates the ability of this invention to accomplish such solder deposition on highly dense circuit patterns. Conductors 23 are preferably bare copper or copper alloy, and do not include plating of additional metallurgy (e.g., nickel or gold) thereon. These conductors may be formed by initially bonding a sheet of copper or copper alloy to layer 21 and then subjecting the sheet to conventional photolithography processing in which a photo-resist material is deposited, exposed, and “developed” away, leaving an open pattern of copper or copper alloy for subsequent etching. This exposed copper or copper alloy is thus etched away, leaving the conductor pattern as shown remaining. Alternatively, the conductors may be formed using what is referred to as a full panel acid copper plating process following which subtractive circuitization occurs. The resulting conductor pattern is designed to accommodate the corresponding pattern of conductors of the associated electronic component(s) to be mounted on the substrate and coupled thereto. Such patterns are well known in the PCB and chip carrier art and further description is not deemed necessary.

In FIG. 2, a solder mask 25 is shown as being deposited on dielectric layer 21 adjacent the conductor 23 shown. Preferably, mask 25 is deposited over substantially the entire upper surface of layer 21 in solid layer form and thereafter exposed and developed using conventional photolithographic processing so as to expose all of the metal conductors. In such a manner, the solder mask will surround each conductor and leave only the upper surfaces (or portions thereof) of the conductors exposed, as shown by the single example depicted in FIG. 2. In one example, this solder mask may be that sold under the product designation “PSR4000” by Taiyo America Inc., Carson City, Nev. Such a mask, if used, is preferably only from about 15 μm to about 40 μm thick. Significantly, however, this thickness is great enough to allow the mask's upper surface to be at least 15 μm higher than the corresponding conductor's upper, exposed surface. This is considered important to assure that the thin layer of solder to be eventually formed on the conductor will not possess a thickness such that it extends above the mask's upper surface following heating of the layer. During the screening operation defined in greater detail below, however, the initial height of the solder paste may exceed the corresponding height of the solder mask 25, because the subsequent heating results in some or substantially all of the volatiles initially found in the paste being removed. Other solder-mask materials may be used herein, including other dry film solder mask (DFSM) materials (examples including those sold under the product names “VACREL” by E.I. duPont de Nemours & Company and “DynaMASK” by the Shipley Company) as well as liquid photo-imageable materials (one example being sold under the product name “Ronascreen SPSR 5600” by the same Shipley Company). It is thus understood that these materials are not limiting of the invention.

In the next step of the invention, as shown in FIG. 3, a quantity of solder material 31 is deposited onto the top surfaces of each of the conductors 23, using a screen 33 having therein a plurality of openings 35 set in an established pattern for each of the selected conductors receiving the paste there-though. Screen 33 is preferably comprised of nickel, a conventional screen material, and has a thickness of from about 25 μm to about 100 μm. Conventional screen printing steps, including using a squeegee 37, are utilized for this deposition. Only the first opening (or series of openings) in the screen is shown filled (with corresponding solder material 31 passing there-through onto the upper surface of conductor 23) but it is understood the remaining openings will also allow solder material 31 to pass through onto conductor 23, as squeegee 37 passes in the direction indicated. Solder material 31 is preferably a known 63:37 tin:lead composition, and is in paste form. Other solder compositions are capable of being used herein, including the more recently developed lead-free solders. Examples of such solders include those comprised of bismuth- tin, bismuth-tin-iron, tin-silver, tin-gold, tin-silver-zinc, tin-silver-zinc-copper, tin-bismuth-silver, tin-copper, tin-copper-silver, tin-indium-silver, tin-antimony, tin-zinc, tin-zinc-indium, copper-based solders, and alloys thereof.

FIGS. 4 and 5 represent two examples of the patterns of openings (and thus the corresponding pattern of solder “islands” formed on conductor 23) capable of being used for each of the individual conductor sites receiving same. In FIG. 4, a total of twenty-one openings 35 are provided, oriented in diagonal orientations within the screen 33. This particular pattern also depicts these openings oriented in both vertical and horizontal orientations as well. In FIG. 5, fewer (here, only twelve) openings 35 are formed within screen 33′, these openings occupying a substantially rectangular 3×4 grid pattern. These pluralities of patterns of openings are understood to only represent examples of several patterns acceptable for use in this invention and the invention is thus not limited to same. The invention is also not limited to any specific number of such openings per pattern. For example, each pattern may include from about three to about fifty openings 35 therein, depending on the overall size of the associated conductor pad's upper surface, the viscosity of the paste being deposited, etc. Preferred solder volumes for each of the total solder paste depositions per conductor are within the range of from about forty to about seventy cubic mils (0.000,000,040 to 0.000,000,070 cubic inches). As above, these volumes may also differ. Significantly, the solder deposits 39 each have a deposited thickness of from about 25 μm to about 35 μm, the result being that these deposits project above the corresponding upper surface of the adjacent mask 25. As indicated above, and further explained below, such deposits include volatiles associated with such pastes. Subsequent heating (reflow) of the formed layer (41′ in FIG. 8) causes these volatiles to be removed, such that the height of the heated layer 41′ will be less than the height of the surrounding mask 25. In one example, it is believed that approximately a thirty percent reduction of the thickness of layer 41′ will occur because of the heat generated during reflow. By way of example, when using paste quantities as defined above, the solder mask upper surface may range from about 5 μm to about 25 μm above the upper surfaces of the reflowed solder layer 41′.

In FIG. 7, a liquid solder flux material 41 is deposited onto the pattern of solder paste deposits 39. In one example, a manifold 43 having a plurality of nozzles 45 as part thereof may be used. In the simplest form, a hand-held air brush device may be used. By way of example of the latter, an External Mix Single Action Air Brush, Model 250 available from Badger Air Brush Company, Illinois, US, may be used (this device indicates that it is capable of applying the contents thereof at low pressures within the range of about fifteen p.s.i. to about fifty p.s.i. These examples are representative only because it is possible to use different applicators, manifolds such as manifold 43 with fewer or more nozzles, (including only one per conductor), and the like. The preferred solder flux material is sold under the product name “Organo Flux 3355-11” solder material by Alpha Metals, a part of Cookson Electronics, having a business location in Jersey City, N.J. Other solder flux materials may be used, including those solder fluxes under the product names “10-4202 Liquid Solder Flux” and “10-4216 Liquid Solder Flux”, both available from Abra Electronics, Champlain, N.Y. The flux application procedure represents a significant aspect of this invention. It has been learned to if the flux is applied at too high pressure, excessive solder dispersion will occur to the extent at least some of the solder will flow onto the adjacent mask. A uniform layer of the resulting solder on the conductor may also not result. In one embodiment, a “fine spray” of flux was deposited such that the flux droplets or particles contacted the paste deposits with just enough pressure that paste dispersion occurred substantially uniformly across the conductor's upper surface without flowing up on the mask. The flux application also caused a substantially uniform “graying” of the combined solder and flux materials across the conductor's upper surface, further indicating substantial uniformity of layer thickness. The spray is so fine that it could also be referred to as being atomized. The flux is applied at room temperature. The result of this flux application is the formation of a substantially continuous layer 41′ of substantially uniformly thick solder material, including the dispersed solder and flux now blended together. This layer 41′ is shown in FIG. 8.

Once layer 41′ has been formed, it is preferably heated to drive out the aforementioned volatiles. Prior to such heating, layer 41′ may exceed the height of the surrounding mask, but the heating, as defined, drives off the volatiles and, in one example, results in a reduction in thickness of the layer 41′ of about thirty percent. Significantly, this reduced thickness of layer 41′ is such that the adjacent mask is higher, extending above the adjacent upper surface of the heated layer. Of further significance, this heated layer is what may be referred to as being “substantially uniformly thick”. It is understood that by the term “substantially uniformly thick” as used to define the solder layer 41′, after heating, is meant to include the presence of a minor “dome.” That is, the dome (typically within the approximate center of the layer) is so minor in height that its uppermost surface does not project above the plane of the corresponding upper surface of mask 25. This is in sharp comparison to the formation of a pronounced dome within the solder which would project above the mask's upper surface. The solder layer as formed herein is also of a thickness so as to substantially prevent such excessive dome formation. In one example, solder layer 41′, after heating, may have a thickness within the range of from about eight um to about twenty um.

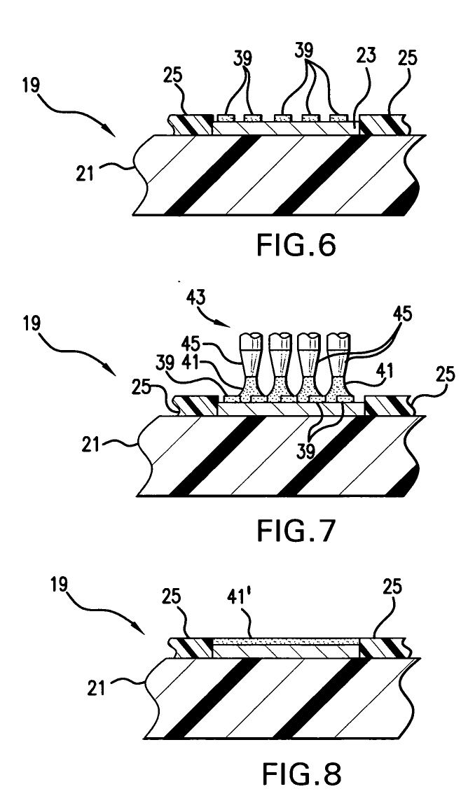

In FIG. 9, such an external conductor (i.e., a solder ball 51) is shown being positioned atop the formed solder layer 41′ and the solder and conductor heated (reflowed) to cause the two to bond and form an electrical connection. In one example, the conductor is one of several solder balls 51 which extend from the undersurface of an electrical component such as a semiconductor chip 53. The number of such conductors, as well as the corresponding number of awaiting conductors, is, as stated, dependent on the physical properties of the specific component. The configuration depicted in FIG. 9 is only meant to be representative of the fact that the solder of layer 41′ bonds to the external conductor. A significantly different configuration than that shown would of course result if the solder layer 41′ contained more material in comparison to that of the corresponding solder ball. This heating (reflow) of the solder material and solder balls will preferably occur following the afore-defined initial heating of the solder layer 41′, as a second reflow operation. The preferred approach, however, is to heat the solder material within layer 41′ and allow it to cool and solidify, following which this second reflow and coupling will occur. The heating of solder layer 41′ alone, prior to coupling, is desirable if the substrate formed herein is to be eventually stored and/or transported to another work station where the solder ball couplings will occur. That is, the solder coupling may occur subsequent to the formation of the solder layer and the cooling thereof to the point of solidification, or, alternatively, it may occur simultaneous with such coupling. The unique teachings of the instant invention allow both possibilities. In one example of the invention, heating of the solder layer 41′ as a sole layer (sans the solder balls) may be accomplished by positioning the substrate within a standard convection oven and heating it to a temperature of from about 200 degrees Celsius (C.) to about 250 degrees C., for a time period of thirty seconds, depending on the melting temperature of the solder used. In one example where the aforementioned 63:37 tin:lead composition was used, the oven was placed at a temperature of about 220 degrees C. to about 230 degrees C. for said time period.

As mentioned, the solder layer 41′ is capable of bonding to other external conductors than the illustrated solder ball. For example, it is also possible to bond the solder to a metal lead such as may form part of a dual-inline-package (DIP) electronic component or the like. Also, following formation of the electrical connections, it is possible to remove the solder mask 25. In one example, this mask material may be removed using a known “stripping” solution comprised of benzyl alcohol.

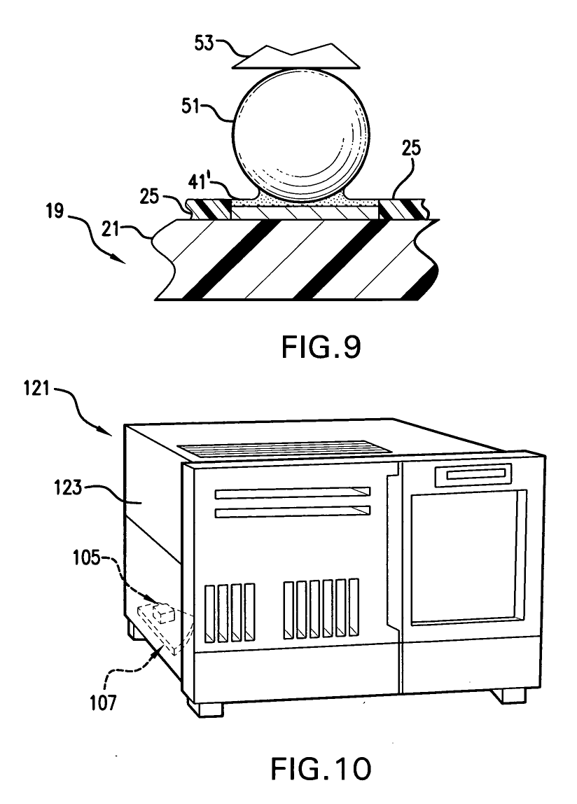

In FIG. 10, there is shown an information handling system 121 in accordance with one embodiment of the invention. System 121 may comprise a personal computer, mainframe computer, computer server, or the like, several types of which are well known in the art. System 121, as taught herein, is adaptable for including therein and thus as part thereof one or more of the circuitized substrates taught herein having electrical components thereon which form electrical assemblies as discussed above. In this form, the circuitized substrate (represented by numeral 107) may be a PCB, a chip carrier, or similar structure. An electrical component positioned thereon is represented by the numeral 105. Electrical coupling of this assembly to the system's circuitry is accomplished using conventional assembling processes, typically used when manufacturing today's computers, servers, etc. and further description is not believe needed. It is further added that the hidden assembly may also be mounted on still a larger PCB or other substrate, one example being a “motherboard” of much larger size, should such a board be required. (These components are shown hidden because these are encased within and thus behind a suitable housing 123 designed to accommodate the various electrical and other components which form part of system 121). Substrate 107, if such a “motherboard”, will typically further include many additional electrical assemblies, including additional printed circuit “cards” mounted thereon, such additional “cards” in turn also possibly including additional electronic components as part thereof. It is thus seen and understood that the electrical assemblies made in accordance with the unique teachings herein may be utilized in several various structures as part of a much larger system, such as information handling system 121. Further description is not believed necessary.

While there have been shown and described what at present considered the preferred embodiments of the invention, it will be obvious to those skilled in the art that various changes and modifications may be made therein without departing from the scope of the invention as defined by the appended claims.

What is claimed is:

1. A method of making a circuitized substrate, said method comprising:
providing a substrate having a first surface thereon;
providing a plurality of metal conductors on said first surface of said substrate in a spaced-apart pattern;
aligning a screen having a plurality of patterns of openings therein over said first surface of said substrate such that selected ones of said patterns of openings align with selected ones of said metal conductors;
depositing a quantity of solder material through said selected ones of said plurality of patterns of openings of said screen and onto said selected ones of said metal conductors such that said solder material does not entirely cover said metal conductors;
depositing a quantity of solder flux material onto said selected ones of said metal conductors having said quantity of solder material thereon to cause said solder material to spread and form a solder layer substantially entirely covering each of said selected ones of said metal conductors; and
heating said solder layers substantially entirely covering each of said selected ones of said metal conductors.

2. The method of claim 1 wherein said dielectric layer is provided from a material selected from the group of materials consisting of fiberglass-reinforced epoxy resin, polytetrafluoroethylene, polyimide, polyamide, cyanate resin, photoimageable material, and combinations thereof.

3. The method of claim 1 wherein said metal conductors are provided in bare copper or copper alloy form.

4. The method of claim 1 wherein said depositing of said quantity of solder material through said selected ones of said openings of said screen and onto said selected ones of said metal conductors such that said solder material does not entirely cover said metal conductors is accomplished using a solder printing operation.

5. The method of claim 4 wherein said quantity of solder material is deposited in paste form.

6. The method of claim 1 wherein said depositing of said quantity of solder flux material onto said selected ones of said metal conductors having said quantity of solder thereon to cause said solder to spread and substantially entirely cover said metal conductors is accomplished using fine spraying or atomization of said quantity of solder flux material.

7. The method of claim 6 wherein said solder flux material is deposited in liquid form.

8. The method of claim 1 wherein said heating of said solder layers is accomplished by convection heating.

9. The method of claim 8 wherein said heating is accomplished at a temperature of from about 200 degrees Celsius (C.) to about 250 degrees C.

10. The method of claim 1 further including providing a solder mask adjacent and substantially surrounding said selected ones of said metal conductors prior to said depositing of said quantity of said solder material through said selected ones of said plurality of patterns of openings within said screen onto said selected ones of said metal conductors.

11. The method of claim 10 wherein said solder deposited on said selected ones of said metal conductors is deposited in paste form having a height greater than the corresponding height of said solder mask so as to project above said solder mask, and the thickness of said solder layer, following said heating, is such that said solder layer will have a height less than said corresponding height of said solder mask.

12. The method of claim 1 wherein said screen is provided with said patterns of said openings therein such that each of said patterns of said openings is provided for each of said metal conductors over which said screen is aligned such that a plurality of individual amounts of said solder material are deposited through said openings to form spaced deposits of said solder material on each of said selected ones of said metal conductors.

13. The method of claim 1 wherein said metal conductors do not include plated metallurgies thereon.

14. The method of claim 1 further including electrically connecting each of said solder layers to a respective external conductor of at least one electronic component to form an electrical assembly.

15. The method of claim 14 wherein said external conductors of said electronic component are solder balls.

16. The method of claim 14 further including positioning said electrical assembly within an information handling system and electrically coupling said electrical assembly to the circuitry of said information handling system so that said electrical assembly is part of said information handling system.
